(19) United States
(12) Patent Application Publication
(10) Pub. No.: US 2014/0152513 A1
(43) Pub. Date: Jun. 5, 2014

(54) VEHICLE ANTENNA DEVICE

(71) Applicant: Kabushiki Kaisha Tokai Rika Denki Seisakusho, Aichi (JP)

(72) Inventors: Motoki NAKAGAWA, Aichi (JP); Fumitaka YOSHIKAWA, Aichi (JP)

(73) Assignee: KABUSHIKI KAISHA TOKAI RIKA DENKI SEISAKUSHO, Aichi (JP)

(21) Appl. No.: 14/082,734

(22) Filed: Nov. 18, 2013

(30) Foreign Application Priority Data
Nov. 30, 2012 (JP) 2012-262894

(51) Int. Cl. H01Q 1/32

(52) U.S. Cl. CPC H01Q 1/3283
USPC 343/713

(57) ABSTRACT

An antenna unit includes first and second antenna units arranged on opposite sides of a vehicle. Each antenna unit includes an antenna body and a second terminal portion. The antenna body includes an antenna portion and a first terminal portion. The antenna portion includes at least two antenna coils each having an axis, and the two axes of the at least two antenna coils intersect each other. The first terminal portion includes first terminals each arranged on two ends of the at least two antenna coils. The second terminal portion is arranged on the vehicle and includes second terminals respectively connected to the first terminals. The second terminal portion of each antenna unit includes a wire-connecting structure, which series-connects the at least two antenna coils. The wire-connecting structures differ between the antenna units.

### CROSS-REFERENCE TO RELATED APPLICATIONS

This application is based upon and claims the benefit of priority from prior Japanese Patent Application No. 2012-262894, filed on Nov. 30, 2012, the entire contents of which are incorporated herein by reference.

### BACKGROUND OF THE INVENTION

The present invention relates to a vehicle antenna device that transmits a wireless signal to a communication subject such as a portable device.

A known electronic key system controls a vehicle through wireless communication performed between a portable device, which is carried by a user, and the vehicle. Japanese Laid-Open Patent Publication No. 2012-193571 describes an electronic key system that automatically performs wireless communication between a vehicle and a portable device when the portable device enters a communication area, which is set around the vehicle. When the portable device is authenticated through wireless communication, the vehicle permits unlocking of the vehicle doors.

In detail, the vehicle includes a handle arranged on a driver side door and a handle arranged on a passenger side door. An antenna is arranged in each door handle to transmit wireless signals. Each antenna forms a communication area around the corresponding door. As a result, when a user who is carrying the portable device approaches any of these doors, wireless communication is automatically performed between the vehicle and the portable device.

The passenger side communication area and the driver side communication area are symmetric with respect to the moving direction of the vehicle. The symmetry of the passenger side and driver side communication areas allows for the user to easily recognize the location of the driver side and passenger side communication areas. That is, a user who usually uses the driver side communication area to unlock the vehicle doors would be able to easily find the passenger side communication area.

To further facilitate the unlocking of vehicle doors, the communication area may be widened in a specific direction. Japanese Laid-Open Patent Publication No. 2009-2111 describes an example of an antenna device having directivity in a specific direction. The antenna device includes three antennas having different directivities. The antenna device has a magnetic field distribution formed by combining the three magnetic field distributions of the three antennas. The combined magnetic field distribution has a directivity that is a combination of the directivities of the three antennas.

When using an antenna device having such directivity in the electronic key system described above, to form symmetric communication areas with respect to the moving direction around the driver seat door and the passenger seat door, the directivity of the driver side antenna device and the directivity of the passenger side antenna device have to be symmetric with respect to the moving direction of the vehicle. Thus, a driver side antenna device and a passenger side antenna device are prepared for the vehicle. In this manner, when the vehicle uses different types of antenna devices, an antenna may be coupled to an incorrect position. Consecruently, the desired communication area may not be obtained.

### SUMMARY OF THE INVENTION

One aspect of the present invention is a vehicle antenna device that forms two communication areas for a portable device at two opposite sides of a vehicle. The two communication areas are symmetric with respect to a straight line extending along a longitudinal direction of the vehicle. The vehicle antenna device includes a first antenna unit arranged at a first lateral side of the vehicle. A second antenna unit is arranged at a second lateral side of the vehicle, which differs from the first lateral side. Each of the first and second antenna units is provided with an antenna body including an antenna portion and a first terminal portion. The antenna portion includes at least two antenna coils each having an axis, and the two axes of the at least two antenna coils intersect each other. The first terminal portion includes first terminals each arranged on two ends of the at least two antenna coils. A second terminal portion is arranged on the vehicle and includes second terminals respectively connected to the first terminals. The second terminal portion of the first antenna unit includes a first wire-connecting structure that series-connects the at least two antenna coils of the first antenna unit. The second terminal portion of the second antenna unit includes a second wire-connecting structure that series-connects the at least two antenna coils of the second antenna unit and differs from the first wire-connecting structure. The two axes of the at least two antenna coils of the first antenna unit and the two axes of the at least two antenna coils of the second antenna unit are symmetric with respect to the straight line extending along the longitudinal direction of the vehicle. The at least two antenna coils of the first antenna unit and the at least two antenna coils of the second antenna unit are wound in the same direction. A signal is applied in opposite directions to the antenna coils of one of the two symmetric sets of the antenna coils and applied in the same direction to the antenna coils of the other one of the two symmetric sets of the antenna coils.

A further aspect of the present invention is a transmission antenna device arranged at a lateral side of the vehicle. The transmission antenna device is provided with an antenna body including an antenna portion and a first terminal portion. The antenna portion includes at least two antenna coils each having an axis, and the two axes of the at least two antenna coils intersect each other. The first terminal portion includes first terminals each arranged on two ends of the at least two antenna coils. A second terminal portion is arranged on the vehicle and includes second terminals respectively connected to the first terminals. The second terminal portion includes one of a first wire-connecting structure, which series-connects the at least two antenna coils, and a second wire-connecting structure, which series-connects the at least two antenna coils and differs from the first wire-connecting structure. When the transmission antenna device is arranged at a first lateral side of the vehicle and the antenna main body is coupled to the second terminal portion having the first wire-connecting structure, the transmission antenna device has a first directivity. When the transmission antenna device is arranged at a second lateral side of the vehicle and the antenna main body is coupled to the second terminal portion having the second wire-connecting structure, the transmission antenna device has a second directivity. The first directivity and the second directivity are symmetric with respect to a straight line extending along a longitudinal direction of the vehicle.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram of a vehicle that performed wireless communication with an electronic key;

FIG. 2A is a schematic diagram showing a communication area, FIG. 2B is a schematic diagram showing how an antenna is coupled to a door handle;

FIG. 3A is a schematic diagram of a first antenna device, and FIG. 3B is a schematic diagram of a second antenna device;

FIG. 4A is a front view showing a case for first and second connectors from an opening, and FIG. 4B is a front view showing a case for an antenna connector from an opening;

FIG. 5A is a schematic diagram showing the connected first antenna device, and FIG. 5B is a schematic diagram showing the connected second antenna device; and

FIG. 6A is schematic diagram showing a modified first antenna device, and FIG. 6B is a schematic diagram showing a modified second antenna device.

### DETAILED DESCRIPTION OF THE INVENTION

One embodiment of vehicle antenna device applied to an electronic key system for a vehicle will now be described.

Vehicle

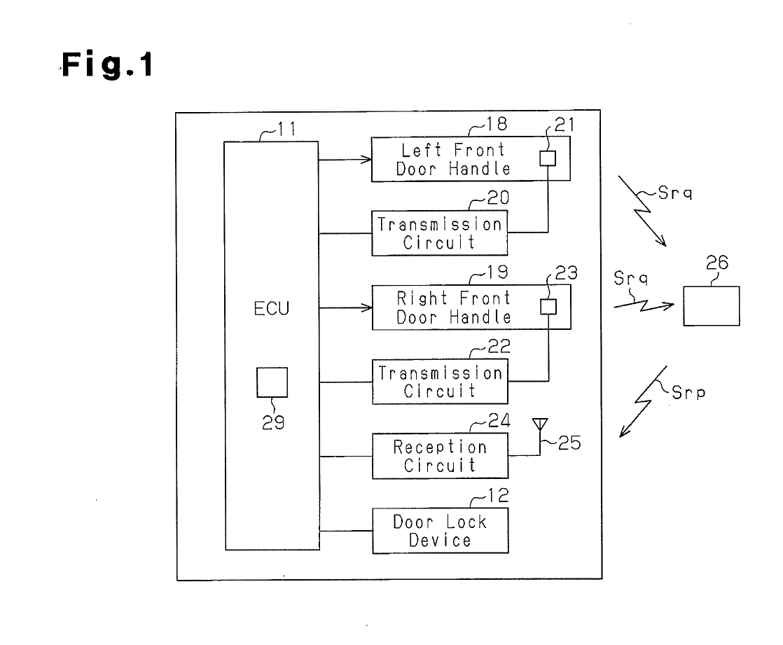

As shown in FIG. 1, the vehicle includes an electronic control unit (ECU) 11 connected to a door lock device 12. The door lock device 12 locks and unlocks doors.

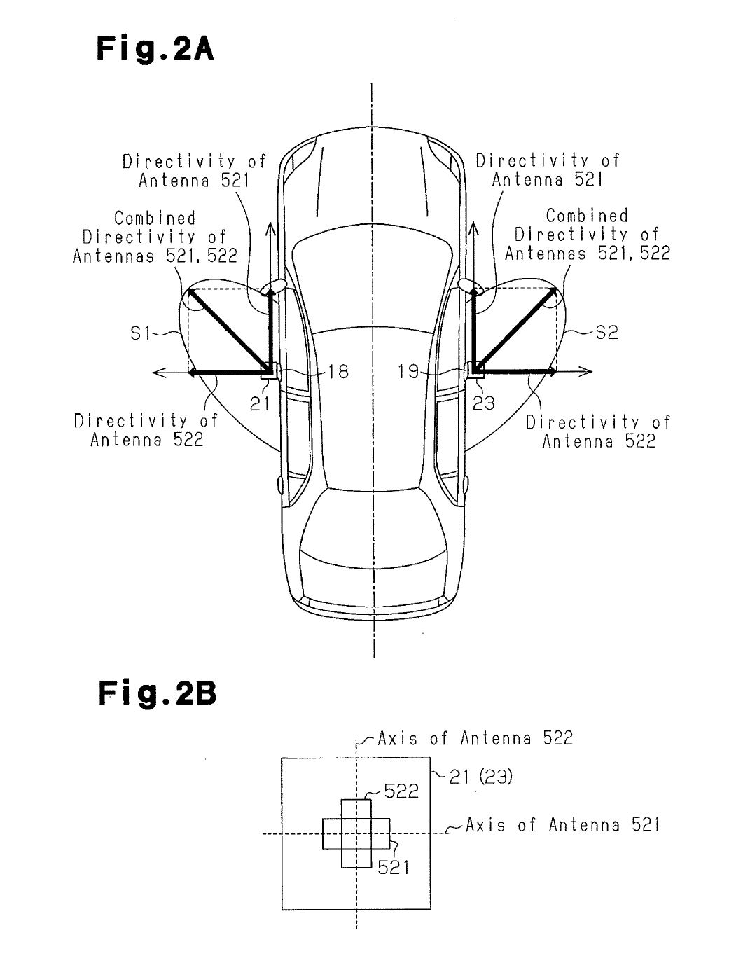

Further, a first transmission circuit 20 connects the ECU 11 to a first transmission antenna unit 21. A second transmission circuit 22 connects the ECU 11 to a second transmission antenna unit 23. A reception circuit 24 connects the ECU 11 to a reception antenna device 25. Referring to FIG. 2A, the first transmission antenna unit 21 is arranged in a handle 18 of the left front door. The second transmission antenna unit 23 is arranged in a handle 19 of a right front door. The first and second transmission antenna units 21 and 23 will be described in detail later. The reception circuit 24 and the reception antenna device 25 are arranged on, for example, a pillar supporting the roof of the vehicle.

Referring to FIG. 1, based on a command from the ECU 11, the first transmission circuit 20 transmits a response request signal Srq, which is a wireless signal, on the low frequency (LF) band from the first transmission antenna unit 21 to the surrounding of the vehicle. Further, based on a command from the ECU 11, the second transmission circuit 22 transmits a response request signal Srq from the second transmission antenna unit 23 to the surrounding of the vehicle. The response request signal Srq is a command requesting a portable device 26, which is carried by a user, to generate a response. Further, the response request signal Srq is transmitted in predetermined control cycles. As shown in FIG. 2A, the transmission of a response request signal Srq forms a reception area of the response request signal Srq near the driver side vehicle door, namely, a communication area S1 of the vehicle and the portable device 26. The transmission of a response request signal Srq also forms a reception area of the response request signal Srq near the passenger side vehicle door, namely, a communication area S2 of the vehicle and the portable device 26. The communication areas S1 and S2 are regions in which a response from the portable device 26 may be expected and are set based on the effective distance of the portable device 26 determined by the specification of the electronic key system (distance from vehicle in which the portable device 26 can receive a wireless signal from the vehicle). The communication areas will be described in detail later.

Referring to FIG. 1, the reception circuit 24 receives a wireless signal on the ultrahigh frequency (UHF) band with the reception antenna device 25. In the present embodiment, a wireless signal on the UHF band is referred to as the response signal Srp, which is transmitted from the portable device 26 in response to a response request signal Srq from the vehicle. The response signal Srp includes identification information unique to the portable device 26.

The ECU 11 includes a memory 29, which stores identification information of the authentic portable device 26 corresponding to the vehicle. The ECU 11 acquires the identification information of the portable device 26 included in the response signal Srp, which is received by the reception circuit 24. The ECU 11 authenticates the portable device 26 by verifying the identification information of the portable device 26 with the identification information stored in the memory 29. When determining that the communicating portable device 26 is authentic, the ECU 11 performs or permits the locking and unlocking of the vehicle doors with the door lock device 12.

Antenna Device

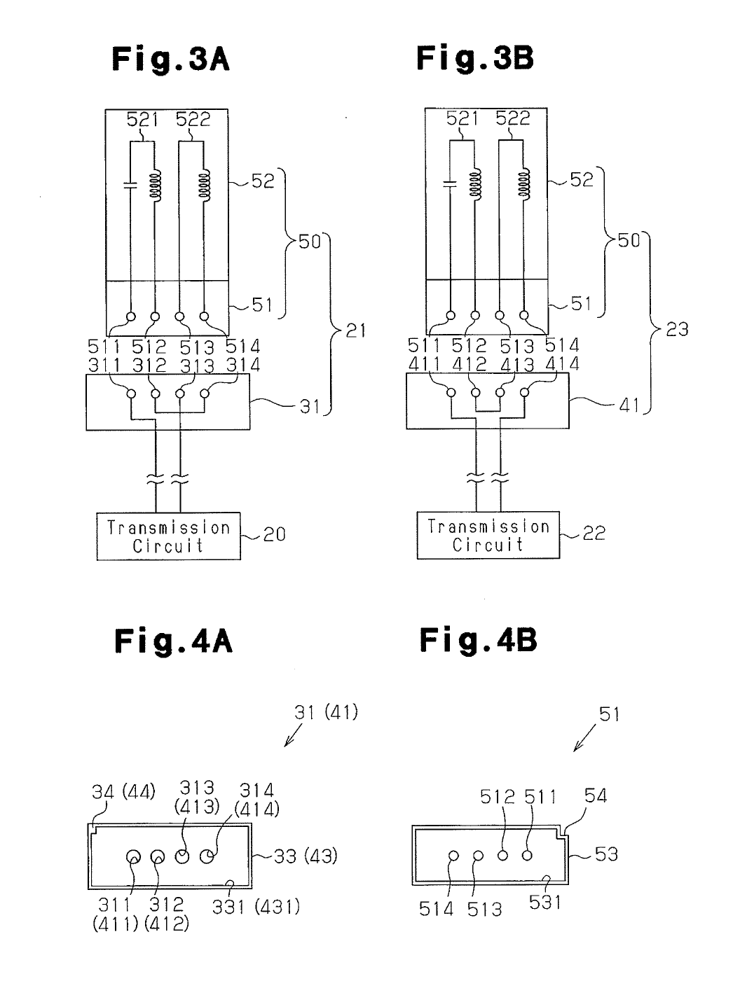

As shown in FIG. 3A, the first transmission antenna unit 21 includes a first vehicle connector 31 and an antenna body 50. As shown in FIG. 3B, the second transmission antenna unit 23 includes a second vehicle connector 41 and an antenna body 50.

As shown in FIG. 3A, the first vehicle connector 31 includes first, second, third, and fourth terminals 311, 312, 313, and 314. The first and third terminals 311 and 313 are electrically connected to the first transmission circuit 20. The first transmission circuit 20 applies a response request signal Srq to between the first terminal 311 and the third terminal 313 with the first terminal 311 serving as the upstream side. The second and fourth terminals 312 and 314 are electrically connected to each other. The first to fourth terminals 311 to 314 are female terminals.

Referring to FIG. 4A, the first vehicle connector 31 is accommodated in a case 33 including a tetragonal opening 331 facing the front of the vehicle. When viewing the case 33 from the opening 331, that is, from the front of the vehicle, the first to fourth terminals 311 to 314 are arranged along a straight line from left to right in the order of the first terminal 311, the second terminal 312, the third terminal 313, and the fourth terminal 314. A projection 34 is formed in the case 33 at the upper left corner.

As shown in FIG. 3B, the second vehicle connector 31 includes first, second, third, and fourth terminals 411, 412, 413, and 414. The first and fourth terminals 411 and 414 are electrically connected to the second transmission circuit 22. The second transmission circuit 22 applies a response request signal Srq to between the first terminal 411 and the fourth terminal 414 with the first terminal 411 serving as the upstream side. The second and third terminals 412 and 413 are electrically connected to each other. The first to fourth terminals 411 to 414 are female terminals.

Referring to FIG. 4A, the second vehicle connector 41 is accommodated in a case 43 that is similar to the case 33 of the first vehicle connector 31. The case 43 of the second vehicle connector 41 includes a tetragonal opening 431 facing the front of the vehicle. When viewing the case 43 from the opening 431, that is, from the front of the vehicle, the first to fourth terminals 411 to 414 are arranged along a straight line from left to right in the order of the first terminal 411, the second terminal 412, the third terminal 413, and the fourth terminal 414. A projection 44 is formed in the case 43 at the upper left corner. The first and second vehicle connectors 31 and 41 correspond to a second terminal portion. The projections 34 and 44 correspond to engaging portions.

As shown in FIGS. 3A and 3B, each antenna body 50 includes an antenna connector 51 and an LF antenna 52. The antenna connector 51 includes first, second, third, and fourth terminals 511, 512, 513, and 514. The LF antenna 52 transmits a wireless signal on the LF band. The antenna connector 51 corresponds to a first terminal portion. The LF antenna 52 corresponds to an antenna portion.

The first to fourth terminals 511 to 514 are male terminals. The first to fourth terminals 511 to 514 of the first transmission antenna unit 21 are connectable to the first to fourth terminals 311 to 314 of the first vehicle connector 31, respectively. The first to fourth terminals 511 to 514 of the second transmission antenna unit 23 are connectable to the first to fourth terminals 411 to 414 of the second vehicle connector 41.

Referring to FIG. 4B, the antenna connector 51 is accommodated in a case 53 including a tetragonal opening 531. The case 53 includes the first to fourth terminals 511 to 514. When viewing the case 53 from the opening 531, the first to fourth terminals 511 to 514 are arranged along a straight line from right to left in the order of the first terminal 511, the second terminal 512, the third terminal 513, and the fourth terminal 514. The case 53 includes a recess 54 formed at the upper right corner. The recess 54 corresponds to an engaged portion.

As shown in FIGS. 3A and 3B, each LF antenna 52 includes first and second antennas 521 and 522. The first and second antennas 521 and 522 may each be a bar antenna formed by winding an electric wire (coil) around a core of a magnetic material such as ferrite. The first antenna 521 includes two ends respectively connected to the first and second terminals 511 and 512. The second antenna 522 includes two ends respectively connected to the third and fourth terminals 513 and 514. As shown in FIG. 2B, the two axes of the first and second antennas 521 and 522 are orthogonal to each other. When coupled to the vehicle, the first antenna 521 has a directivity in a direction orthogonal to its axis, that is, in the longitudinal direction of the vehicle. Further, in the same manner as the first antenna 521, when coupled to the vehicle, the second antenna 522 has a directivity in a direction orthogonal to its axis, that is, in the lateral direction of the vehicle. The axes of the first and second antennas 521 and 522 are symmetric with respect to a straight line extending in the moving direction (longitudinal direction) of the vehicle. Although not shown in the drawings, the coils of the first and second antennas 521 and 522 are wound in the same direction.

Operation of Antenna Device

The operation of the first and second transmission antenna units 21 and 23 will now be described.

As shown in FIGS. 3A and 3B, the structure of the antenna body 50, which transmits the response request signal Srq, is the same in both of the first and second transmission antenna units 21 and 23. Thus, the antenna body 50 may be coupled to any one of the first and second vehicle connectors 31 and 41. Accordingly, this avoids situations in which the antenna body 50 is coupled to the wrong connector.

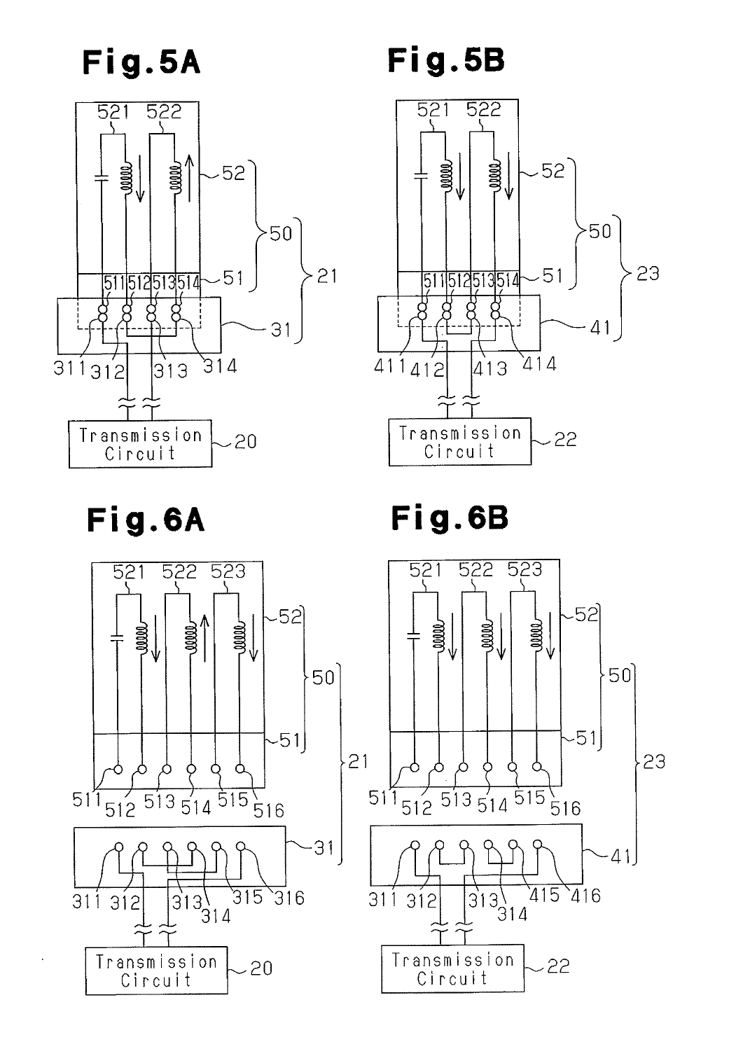

Further, as shown in FIG. 4A, the projections 34 and 44 are formed in the left upper corners of the cases 33 and 43 for the first and second vehicle connectors 31 and 41, respectively. As shown in FIG. 4B, the right upper corner of the case 53 for the antenna connector 51 includes the recess 54. The recesses 54 of the antenna connectors 51 have to conform to the projections 34 and 44 of the corresponding first and second vehicle connectors 31 and 41 to couple the antenna bodies 50 to the first and second vehicle connectors 31 and 41. Thus, as shown in FIGS. 5A and 5B, when the first and second vehicle connectors 31 and 41 are coupled to the corresponding antenna bodies 50, the first terminals 511 of the antenna connectors 51 are connected to the first terminals 311 and 411 of the first and second vehicle connectors 31 and 41, respectively. Further, the second terminals 512 of the antenna connectors 51 are connected to the second terminals 312 and 412 of the first and second vehicle connectors 31 and 41, respectively. The third terminals 513 of the antenna connectors 51 are connected to the third terminals 313 and 413 of the first and second vehicle connectors 31 and 41, respectively. The fourth terminals 514 of the antenna connectors 51 are connected to the fourth terminals 314 and 414 of the first and second vehicle connectors 31 and 41, respectively. The terminals cannot be connected in other combinations due to interference of the projections 34 and 44 in the cases 33 and 43 of the first and second vehicle connectors 31 and 41 with the cases of the antenna connectors 51.

As shown in FIG. 3A, the first and third terminals 311 and 313 of the first vehicle connector 31 are electrically connected to the first transmission circuit 20. The second and fourth terminals 312 and 314 are electrically connected to each other. Further, the first transmission circuit 20 applies a response request signal Srq to between the first terminal 311 and the third terminal 313 with the first terminal 311 serving as the upstream side. As shown in FIG. 3B, the first and fourth terminals 411 and 414 of the second vehicle connector 41 are electrically connected to the second transmission circuit 22. The second and third terminals 412 and 413 are electrically connected to each other. Further, the second transmission circuit 22 applies a response request signal Srq to between the first terminal 411 and the fourth terminal 414 with the first terminal 411 serving as the upstream side. Thus, as shown by the arrows in FIGS. 5A and 5B, the response request signal Srq is applied in the same direction to the first antenna 521 of the first transmission antenna unit 21 and the first antenna 521 of the second transmission antenna unit 23. Accordingly, as shown in FIG. 2A, the first antenna 521 of each of the first and second transmission antenna units 21 and 23 forms a magnetic field distribution having a directivity extending toward the front of the vehicle. As shown in FIGS. 5A and 5B, the response request signal Srq is applied in opposite directions to the second antenna 522 of the first transmission antenna unit 21 and the second antenna 522 of the second transmission antenna unit 23. Thus, as shown in FIG. 2A, the second antenna 522 of each of the first and second transmission antenna units 21 and 23 forms a magnetic field distribution having a directivity extending toward the outer side in the lateral direction of the vehicle. That is, the directivity of the second antenna 522 in the first transmission antenna unit 21 extends in a direction opposite to the directivity of the second antenna 522 in the second transmission antenna unit 23. The first transmission antenna unit 21 forms a magnetic field distribution, namely, the communication area S1, having a directivity obtained by combining the two directivities of the first and second antennas 521 and 522 of the first transmission antenna unit 21. Further, the second transmission antenna unit 23 forms the communication area S2 having a directivity obtained by combining the two directivities of the first and second antennas 521 and 522 of the second transmission antenna unit 23. Accordingly, the communication area S1 formed by the first transmission antenna unit 21 and the communication area S2 formed by the second transmission antenna unit 23 are symmetric and located at opposite sides of the vehicle.

The present embodiment has the advantages described below.

(1) The antenna bodies 50, which transmit the response request signal Srq, have the same structure in both of the first and second transmission antenna units 21 and 23. Thus, the antenna body 50 may be coupled to any one of the first and second vehicle connectors 31 and 41. This avoids situations in which the antenna body 50 is coupled to the wrong connector. Further, the antenna body 50 is coupled to the first vehicle connector 31 of the first transmission antenna unit 21. The antenna body 50 is also coupled to the second vehicle connector 41 of the second transmission antenna unit 23. The second vehicle connector 41 includes terminals having a wire-connecting structure that differs from that of the terminals in the first vehicle connector 31. Due to the difference in the wire-connecting structure between the first vehicle connector 31 and the second vehicle connector 41, in the present example, the response request signal Srq is applied in the same direction to the first antenna 521 of the first transmission antenna unit 21 and the first antenna 521 of the second transmission antenna unit 23. Further, the response request signal Srq is applied in opposite directions to the second antenna 522 of the first transmission antenna unit 21 and the second antenna 522 of the second transmission antenna unit 23. Thus, a signal is applied in opposite directions to the antenna coils of one of the two symmetric sets of the antenna coils and applied in the same direction to the antenna coils of the other one of the two symmetric sets of the antenna coils. As a result, the communication area S1 formed by the first transmission antenna unit 21 and the communication area S2 formed by the second transmission antenna unit 23 are symmetric and located at opposite sides of the vehicle.

(2) The projections 34 and 44 are located on the left upper corner in the cases 33 and 43 for the first and second vehicle connectors 31 and 41, respectively. The recess is arranged in the right upper corner of the case 53 for the antenna connector 51. Thus, the recesses 54 of the antenna connectors 51 have to conform to the projections 34 and 44 of the corresponding first and second vehicle connectors 31 and 41 to couple the antenna bodies 50 to the first and second vehicle connectors 31 and 41.

It should be apparent to those skilled in the art that the present invention may be embodied in many other specific forms without departing from the spirit or scope of the invention. Particularly, it should be understood that the present invention may be embodied in the following forms.

In the above embodiment, each of the first and second antennas 521 and 522 in the antenna body 50 has two axes but may have three axes. For example, as shown in FIGS. 6A and 6B, a third antenna 523 is provided in addition to the first and second antennas 521 and 522. The third antenna 523 has two ends respectively connected to fifth and sixth terminals 515 and 516. In this case, as shown in FIG. 6A, the fifth and sixth terminals 315 and 316 are arranged in the first vehicle connector 31. The first and sixth terminals 311 and 316 are electrically connected to the first transmission circuit 20. The second and fourth terminals 312 and 314 are electrically connected to each other. Further, the third and fifth terminals 313 and 315 are electrically connected to each other. The first transmission circuit 20 applies the response request signal Srq to between the first terminal 311 and the sixth terminal 316 with the first terminal 311 serving as the upstream side. As shown in FIG. 6B, fifth and sixth terminals 415 and 416 are arranged in the second vehicle connector 41. The first and sixth terminals 411 and 416 are electrically connected to the second transmission circuit 22. The second and third terminals 412 and 413 are electrically connected to each other. Further, the fourth and fifth terminals 414 and 415 are electrically connected to each other. The second transmission circuit 22 applies the response request signal Srq to between the first terminal 411 and the sixth terminal 416 with the first terminal 411 serving as the upstream side. In this structure, as shown in FIGS. 6A and 6B, the response request signal Srq is applied in the same direction to the first and third antennas 521 and 523 of the first transmission antenna unit 21 and the first and third antennas 521 and 523 of the second transmission antenna unit 23. Further, the response request signal Srq is applied in opposite directions to the second antennas 522 of the first transmission antenna unit 21 and the second antenna 522 of the second transmission antenna unit 23. In this manner, even when the antenna body 50 has three axes, the signal may be applied in opposite directions to only one axis. This easily allows for the communication areas to be symmetric.

In the above embodiment, the projections 34 and 44 of the first and second vehicle connectors 31 and 41 and the recess 54 of the case 53 for the antenna connector 51 may be omitted. This also allows for advantage (1) of the above embodiment to be obtained.

In the above embodiment, the first to fourth terminals 311 to 314 and 411 to 414 of the first and second vehicle connectors 31 and 41 are male terminals, and the first to fourth terminals 511 to 514 of the antenna connector 51 are female terminals. However, the male and female relation may be reversed. Such a structure would also obtain the same advantages as the above embodiment.

In the above embodiment, the first transmission antenna unit 21 is arranged in the handle 18 of the left front door, and the second transmission antenna unit 23 is arranged in the handle 19 of the right front door. However, the first and second transmission antennas 21 and 23 may be arranged in the handles of the left and right rear doors.

In the above embodiment, the first and second antennas 521 and 522 are bar antennas formed by winding an electric wire (coil) around a core of a magnetic material such as ferrite. However, the first and second antennas 521 and 522 may be coil antennas from which the magnetic cores are omitted.

In the above embodiment, the axis of the first antenna 251 extends in the lateral direction of the vehicle, and the axis of the second antenna 522 extends in the longitudinal direction of the vehicle. However, these axes may extend in other directions. The axes of the first and second antennas 521 and 522 only need to be symmetric with respect to a line extending in the moving direction of the vehicle.

In the above embodiment, the first and second transmission antenna units 21 and 23 are respectively arranged on the handles 18 and 19 of the driver side and passenger side doors but may be arranged on the handles of the rear doors. Further, antenna devices may be arranged at locations other than the door handles such as the left and right pillars or the door mirrors. This allows for communication areas to be formed in the passenger compartment. In such a case, the same advantages as the above embodiment would be obtained.

The present examples and embodiments are to be considered as illustrative and not restrictive, and the invention is not to be limited to the details given herein, but may be modified within the scope and equivalence of the appended claims.

1. A vehicle antenna device that forms two communication areas for a portable device at two opposite sides of a vehicle, wherein the two communication areas are symmetric with respect to a straight line extending along a longitudinal direction of the vehicle, the vehicle antenna device comprising:
a first antenna unit arranged at a first lateral side of the vehicle;
a second antenna unit arranged at a second lateral side of the vehicle, which differs from the first lateral side, wherein
each of the first and second antenna units includes
an antenna body including an antenna portion and a first terminal portion, wherein the antenna portion includes at least two antenna coils each having an axis, and the two axes of the at least two antenna coils intersect each other, and wherein the first terminal portion includes first terminals each arranged on two ends of the at least two antenna coils; and
a second terminal portion arranged on the vehicle and including second terminals respectively connected to the first terminals, wherein
the second terminal portion of the first antenna unit includes a first wire-connecting structure that series-connects the at least two antenna coils of the first antenna unit,
the second terminal portion of the second antenna unit includes a second wire-connecting structure that series-connects the at least two antenna coils of the second antenna unit and differs from the first wire-connecting structure,
the two axes of the at least two antenna coils of the first antenna unit and the two axes of the at least two antenna coils of the second antenna unit are symmetric with respect to the straight line extending along the longitudinal direction of the vehicle,
the at least two antenna coils of the first antenna unit and the at least two antenna coils of the second antenna unit are wound in the same direction, and
a signal is applied in opposite directions to the antenna coils of one of the two symmetric sets of the antenna coils and applied in the same direction to the antenna coils of the other one of the two symmetric sets of the antenna coils.

2. The vehicle antenna device according to claim 1, wherein
one of the first terminal portion and the second terminal portion includes an engaging portion that is engaged with only an engaged portion of the other one of the first terminal portion and the second terminal portion, and
the first terminals and the second terminals are connected only when the engaging portion is engaged with the engaged portion.

3. A transmission antenna device arranged at a lateral side of the vehicle, the transmission antenna device comprising:
an antenna body including an antenna portion and a first terminal portion, wherein the antenna portion includes at least two antenna coils each having an axis, and the two axes of the at least two antenna coils intersect each other, and wherein the first terminal portion includes first terminals each arranged on two ends of the at least two antenna coils; and
a second terminal portion arranged on the vehicle and including second terminals respectively connected to the first terminals, wherein
the second terminal portion includes one of a first wire-connecting structure, which series-connects the at least two antenna coils, and a second wire-connecting structure, which series-connects the at least two antenna coils and differs from the first wire-connecting structure,
when the transmission antenna device is arranged at a first lateral side of the vehicle and the antenna main body is coupled to the second terminal portion having the first wire-connecting structure, the transmission antenna device has a first directivity, and
when the transmission antenna device is arranged at a second lateral side of the vehicle and the antenna main body is coupled to the second terminal portion having the second wire-connecting structure, the transmission antenna device has a second directivity, and
the first directivity and the second directivity are symmetric with respect to a straight line extending along a longitudinal direction of the vehicle.
